(19) United States
(12) Patent Application Publication
(10) Pub. No.: US 2021/0304142 A1
(43) Pub. Date: Sep. 30, 2021

(54) END-USER FEEDBACK REPORTING FRAMEWORK FOR COLLABORATIVE SOFTWARE DEVELOPMENT ENVIRONMENTS

(71) Applicants: Atlassian Pty Ltd., Sydney (AU); Atlassian Inc., San Francisco, CA (US)

(72) Inventors: Noam Bar-on, San Francisco, CA (US); Mathew Ho, Sunnyvale, CA (US); Bharath Booshan Lakshmi Narayanan, Sunnyvale, CA (US)

(21) Appl. No.: 16/855,638

(22) Filed: Apr. 22, 2020

Related U.S. Application Data
(60) Provisional application No. 63/003,086, filed on Mar. 31, 2020.

(51) Int. Cl. G06Q 10/10; G06F 8/73; G06F 8/77

(52) U.S. Cl. CPC G06Q 10/101; G06F 8/77; G06F 8/73

(57) ABSTRACT

An issue tracking service includes a host device executing an issue tracking service in communication with a client device executing at least one of an end-user feedback reporting framework and/or an client application. The end-user feedback reporting framework solicits feedback from a user of the client application and provides that input as a well-formatted input to the issue tracking service.

### CROSS-REFERENCE TO RELATED APPLICATION(S)

This application is a nonprovisional patent application of and claims the benefit of U.S. Provisional Patent Application No. 63/003,086, filed Mar. 31, 2020 and titled “End-User Feedback Reporting Framework for Collaborative Software Development Environments,” the disclosure of which is hereby incorporated herein by reference in its entirety.

### TECHNICAL FIELD

Embodiments described herein relate to software development environments and, in particular, to systems and methods for collecting feedback from end-users and automatically generating therefrom inputs to a collaborative software development environment.

### BACKGROUND

An organization can leverage a collaborative software development environment to facilitate completion of work by a team of developers to advance a common software development goal. A collaborative software development environment may provide one or more discrete services that can be leveraged by the team to improve efficiency, such as an issue tracking service, a secure messaging service, a project management service, and the like.

In many cases, however, regularly interacting with multiple discrete services of a collaborative software development environment (e.g., adding, editing, and/or closing issues reports tracked by an issue tracking service, updating documentation hosted by a documentation service, and so on) may be time and/or resource consuming for individual developers, reducing team productivity and reducing usefulness of the collaborative software development environment.

Further, conventional collaborative software development environments often exacerbate challenges presented by consuming and responding to end-user feedback. For example, typically end-user feedback for software products is provided by end-users to (1) software marketplaces and not to developers, or (2) to generic support/feature request email inboxes. In either conventional case, human intervention is required such that received end-user feedback is properly input (e.g., as a bug report, as a feature request, and so on) to a collaborative software development environment so that developers of the software product can address the user feedback.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified system diagram of an issue tracking system, such as described herein.

FIG. 2 depicts an example client device executing an instance of a client application including an end-user feedback reporting framework, such as described herein, that may communicably couple to an issue tracking service, such as depicted in FIG. 1.

FIGS. 3A-3D depict example graphical user interfaces that may be rendered by an instance of a client application, such as the client application of FIG. 2, to facilitate interaction between a user of the client application, an end-user feedback reporting framework such as described herein, and an issue tracking service, such as depicted in FIG. 1.

FIG. 4 depicts a simplified system diagram of a client device executing an instance of a client application and an instance of an end-user feedback reporting framework communicably coupled to an issue tracking service, such as depicted in FIG. 1.

FIG. 5 is a flowchart depicting example operations of a method of leveraging end-user feedback to provide input to an issue tracking service, such as described herein.

FIG. 6 is a flowchart depicting example operations of a method of collecting end-user feedback to provide input to an issue tracking service, such as described herein.

FIG. 7 is a flowchart depicting example operations of a method of leveraging end-user feedback to modify how content is displayed or prioritized in an issue tracking service, such as described herein.

The use of the same or similar reference numerals in different figures indicates similar, related, or identical items.

### DETAILED DESCRIPTION

Embodiments described herein relate to systems and methods for soliciting and receiving end-user feedback regarding a particular software product and generating, with that feedback, well-formatted and data-rich input to one or more services of a collaborative software development environment, thereby establishing (and automating) a feedback loop between end-users of the software product and various tools leveraged by developers to produce and improve that software product.

More specifically, as a result of architectures described herein, end-users of a software product can provide direct, user-relevant feedback (e.g., bug reports, feature suggestions, user stores, diversions from expected behaviors, and so on) to developers of that software product, without requiring quality control engineers or other individual to manually convert unstructured user feedback reports into a form and/or format consumable by one or more services of a collaborative software development environment. In a more simple and non-limiting phrasing, embodiments described herein focus on simplifying and automating processes of collecting and processing end-user feedback as input to software tool leveraged by teams of software developers, such as issue tracking services, project management services, and the like.

Embodiments described herein are presented in contrast with conventional systems in which end-user feedback intake systems (e.g., email, web forms, and so on) are (1) entirely decoupled from collaboration tools used by developers of conventional software products, and, (2) in many cases, decoupled from those software products themselves. For example, in conventional systems an end-user may be required to draft an email or fill a web form (which may, in some cases, require the end-user to launch a separate software application) in order to provide feedback to developers of a conventional software product.

In these conventional systems, individual developers and/or dedicated personnel (such as quality control engineers or data entry contractors) may be tasked with manually converting end-user feedback into inputs suitable for collaboration tools used by developers, such as issue tracking services. This task may be especially difficult for software products localized in many different languages. Often, data quality engineers and/or data entry contractors are not fluent in multiple languages and may not be able to readily process or understand end-user feedback provided in certain languages. Further, manual data entry is subject to human error and misinterpretation of end-user feedback, especially if that feedback is not adequately detailed (e.g., a data entry contractor may be unable to easily determine what button or user interface element an end-user refers to when that end-user provides feedback of: “the ‘cancel’ button doesn't work”). As a result, a substantial quantity of conventionally-provided end-user feedback may be ignored, discarded, or otherwise misinterpreted.

According, as may be known to persons of skill in the art, it is typical that conventional end-user feedback intake systems exhibit substantial delays between receiving end-user feedback and implementing changes addressing that feedback, presuming that feedback provided by end-users is accurately or comprehensively input to collaboration tools used by developers of that software product at all. In addition, conventional systems typically do not have any ability to provide updates to end-users that have provided feedback; an end-user is typically unaware whether his or her feedback has been received, has been reviewed, has been discarded, has been addressed, or otherwise more generally recognized at all. As a result of these and other structural inefficiencies of existing feedback intake systems, most end-users are typically not motivated to provide feedback at all.

To account for these and other inefficiencies of existing systems, generally and broadly, embodiments described herein provide a drop-in framework for developers of software products that facilitates processes of receiving and processing unstructured end-user feedback regarding a particular feature of a particular software product and for automatically directing that feedback, via one or more services of a collaborative software development environment, to one or more software developers directly responsible for maintaining or developing that specific software feature. As a result of embodiments described herein, user feedback may be received and processed in a substantially more time-efficient manner, dramatically increasing the speed with which specific concerns of specific end-users are addressed.

Further, as a result of the herein described coupling of end-user instances of software products and collaboration tools/services used by the developers of those software products, end-users that have provided feedback can be regularly updated on the status of their feedback reports (e.g., whether the report has been received, reviewed, assigned, fixed, and so on).

Further still, as a result of the herein described coupling of end-user instances of software products and collaboration tools/services used by the developers of those software products, developers can reach out to specific end-users to solicit more information, for beta or alpha testing, or for any other suitable purpose.

Further, as a result of the herein described coupling of end-user instances of software products and collaboration tools/services used by the developers of those software products, developers can aggregate substantially more granular usage statistics and can, therewith, inform software development decision-making based on user-base demographics. For example, a framework such as described herein can gather or collect information specific to individual end-users that can be included in issue reports (or other communications) transacted between the framework and collaboration tools/services used by developers of that respective software product.

For example, with such an architecture, a team of software developers may be able to determine that users of their software products from a particular company, or having a particular job title, or having a particular educational background, or having a particular technical credential or experience provide feedback in different ways and regarding different features or user interface elements of a particular software product.

For example, technical users may provide feedback to functionality of a menu item more frequently than non-technical users who may provide user interface feedback more frequently instead. More generally and broadly, a person of skill in the art may readily appreciate that as a result of the herein described communications between end-user instances of software products and collaboration tools/services used by developers of those products, demographic information of the end-user base may be usefully aggregated to provide more informed software development roadmap decisions.

Further still, as a result of the herein-described coupling of end-user instances of software products and collaboration tools/services used by the developers of those software products, end-user feedback metadata (e.g., report counts by user interface element, reports containing a particular word or set of words, reports from particular end-users, and so on) can be leveraged to triage specific bugs/coding errors that have been reported most frequently and/or by users of a particular user group (e.g., executives' feedback may be prioritized over other users). For example, if a high number of end-users provide feedback related to a particular graphical user interface element, a software development team may be well-advised to address that particular bug over other reported bugs. In other cases, systems such as described herein can be leveraged to generate heat maps or other visual representations of feedback-triggering graphical user interface elements such that both developers and non-developer team members can readily and quickly understand which graphical user interface elements trigger the most end-user feedback reports. Such heat maps/visual representations may be leveraged by user interface and user experience designers to inform decisions regarding placement, dimensions, and/or other characteristics of graphical user interface elements.

More simply, it may be appreciated that by coupling end-user instances of software products with collaboration tools/services used by developers of those software products, end-user feedback and communications (or status updates regarding that end-user feedback) can be more efficiently transacted directly between relevant developers and end-users, thereby shortening continuous integration, delivery, development, and/or deployment pipelines. By leveraging the systems and methods described herein, improved software products can be released to production more quickly and efficiently.

An example of a collaborative software development environment, as described herein, can be implemented in whole or in part as software executed by one or more virtual or physical server(s) or other computing appliances or communicably coupled combination of appliances that provides a team of individuals with a centralized or federated system for communicating and exchanging information and maintaining version control over shared source code related to one or more software products. A collaborative software development environment, in many examples, provides or otherwise hosts multiple discrete services that can be independently or collectively leveraged by members of a software development team. For example, a collaborative software development environment can include services such as, without limitation: an issue tracking service; a code repository service; a messaging service; a documentation service; a project management service; and so on.

One of skill in the art may appreciate that a collaborative software development environment, such as described herein, along with its respective services, functions, and operations can be implemented in a number of suitable ways to conform to a number of open or closed source protocols (e.g., version control protocols, messaging protocols, and so on) or techniques and, as such, it is understood that as used herein the phrase “collaborative software development environment” refers to any and all software platforms and systems, whether centralized or distributed and whether implemented with a client-server architecture, a serverless architecture, an event-driven architecture, or any suitable combination thereof.

For simplicity of illustration and description, the embodiments described herein reference an example collaborative software development environment including an issue tracking service, but it may be appreciated that this is merely one example service that can be provided by a collaborative software development environment and in other constructions and architectures, different and/or additional services may be provided by such an environment and may leverage methods and systems described herein.

An “issue tracking service,” as described herein, is a project management system or tool that can be implemented in whole or in part as software executed by a virtual, containerized, or physical server or other computing appliance or combination of appliances that provides a team of individuals with a means for communicating and exchanging information with one another.

In many examples, an issue tracking service is configured for use by a software development team to exchange information that can facilitate the completion and assignment of discrete tasks related to software development projects from creation of new user stories (i.e., user-perspective feature requests or desired functionality), through proof of concept testing, through integration testing, through release of software to one or more users, and through reporting and fixing of software errors or inefficiencies (“bugs”).

In many examples, an issue tracking service, however configured or used by a team of individuals or an organization, is implemented with a client-server architecture in which a host server or service of the issue tracking service exchanges requests and responses (which may comply with a communication protocol such as HTTP, TCP, UDP, and the like), with one or more clients. In other cases, event-driven architectures may be used. In this manner, a host server of an issue tracking service can serve information to each client, and in response, each client can render a graphical user interface on a display to present that information to the user (e.g., a developer) of that respective client.

Although it may be appreciated that an issue tracking service can be configured in many ways and/or can be leveraged by a number of different teams for a number of different purposes, including non-software purposes, for simplicity of description the embodiments described herein reference an issue tracking service configured for use by a software development team a s apportion of a suite of software tools or services typically referred to as collaborative software development environment. In these constructions, the issue tracking service can be configured to receive from clients one or more “issue reports” that contain information describing a task to improve the performance or function of a particular software application.

An issue report may capture user stories, epics, user interface improvements, designs or other non-functional tasks (herein, “features” or “feature requests”). In other cases, an issue report can capture information related to unintended behaviors of a given software product, typically referred to as a “bug.” For simplicity of description, the embodiments that follow reference an issue tracking service configured for use by a software development team primarily to track bugs discovered in existing software products.

More specifically, embodiments described herein reference systems and methods for soliciting, receiving, and inputting unstructured end-user feedback to an issue tracking service of a collaborative software development environment by leveraging an “end-user feedback reporting framework” bundled or otherwise provided with a software application distributed to an end-user. The end-user feedback reporting framework may be a library, framework, plugin, API, or any other suitable first-party software that may be distributed with third-party applications. The end-user feedback reporting framework communicably couples to the issue tracking service to provide information to and to receive information from the issue tracking service. In addition, the end-user feedback reporting framework is typically configured to integrate with, and/or overlay, a graphical user interface of the software application (herein, the “client application” or the “host application”), to provide the end-user with an option to provide feedback directly to the developer(s) of that application (via the issue tracking service).

For example, the end-user feedback reporting framework may cause the graphical user interface to render a button soliciting user feedback, such as a button entitled “Provide Feedback.” In other examples, the end-user feedback reporting framework can register a callback for (or otherwise subscribe to or hook into) user interaction events, such as gesture events, touch events, cursor hotspots, and the like. In yet other examples, the end-user feedback reporting framework may insert an option to provide feedback into a settings menu of the client application. In yet further examples, the end-user feedback reporting framework can present a floating overlay or drawer that extends over a graphical user interface of the client application. These examples are not exhaustive; in other examples and embodiments, the end-user feedback reporting framework may integrate with the client application to receive end-user input in another manner.

The client application may be defined by executable code stored in a memory of, and executed by a processor of, a client device. In particular, as noted with respect to other embodiments described herein, a client device (and/or a host device) may be supported by one or more virtual or physical hardware devices, referred to herein as resource allocations, that may be leveraged to perform, coordinate, or otherwise instantiate one or more services or functions of the client device. For example, a client device as described herein can include a processor allocation, a memory allocation, and/or a network connection allocation that can be leveraged to instantiate the client application. In particular, the client application can be defined by executable code and/or binary code stored in a persistent memory allocation. A processor allocation can be configured to access the persistent memory allocation to retrieve the executable instructions and/or binary code and can be configured to load at least a portion thereof into a working memory allocation. With the support and assistance of the memory allocation, the processor allocation can instantiate the client application (in some examples, over an operating system) to facilitate interaction with, and use of the client application by, the end-user.

Once the end-user feedback reporting framework receives a user input indicating an intent of the user to provide feedback regarding the client application, the end-user feedback reporting framework can optionally present or generate an overlay over the graphical user interface of the client application to present an input dialog to the end-user including at least one field soliciting specific information from the end-user. In many implementations, this field may solicit free-form or otherwise unstructured text input.

For example, the overlaid graphical user interface can include, without limitation: an input box requesting the end-user provide a title describing the end-user's feedback; a text input box requesting the end-user provide a detailed description of the end-user's feedback; a file handler requesting the end-user upload or attach a screenshot and/or screen recording providing context for the end-user's feedback; and so on. It may be appreciated that these examples are not exhaustive of the various types of inputs that may be requested of a user by an end-user feedback reporting framework, such as described herein.

In other examples, once the end-user feedback reporting framework receives a user input indicating an intent of the user to provide feedback regarding the client application, the end-user feedback reporting framework can request that the end-user select one or more graphical user interface elements that relate to the end-user's feedback. Thereafter, the end-user may select one or more graphical user interface elements, functionalities of which may be temporarily disabled by the end-user feedback reporting framework to facilitate selection of those elements by the end-user.

Once the end-user has selected at least one graphical user interface element, the end-user feedback reporting framework can be configured to retrieve (or generate) a unique identifier associated with the selected graphical user interface elements. In some examples, each individual graphical user interface element may include an attribute with a unique identifier that may be retrieved by the end-user feedback reporting framework. In other cases, the end-user feedback reporting framework may be configured to generate a hash or other unique value from one or more unique properties of the one or more selected graphical user interface elements (e.g., title, localization strings, dimensions, anchor points, and so on).

Thereafter, once the end-user feedback reporting framework has obtained a unique identifier associated with a graphical user interface element selected by the user, the end-user feedback reporting framework can optionally present or generate an overlay over the graphical user interface of the client application to present an input dialog to the end-user including at least one field soliciting specific descriptive information from the end-user, such as described above.

In these and other related examples, an end-user feedback reporting framework such as described herein can be configured to, generally and broadly, solicit and/or receive as input unstructured text input from an end-user that describes an issue experienced by that end-user. Once that unstructured input is received, the end-user feedback reporting framework can supplement that input with information specifically identifying portions of the client application (herein, referred to as “graphical user interface element identifiers”) that the end-user regards as a source or cause of the end-user's feedback.

With this collected information, an end-user feedback reporting framework such as described herein can populate an issue report template that, in turn, can be submitted to the issue tracking service to which the framework is configured to communicably couple. As used herein the terms “issue report template,” “unsubmitted issue report,” “draft issue report” and similar phrasing refer to issue reports that have yet to be submitted to an issue tracking system. Similarly, it is understood that the term “issue report” refers to a discrete record in a database of an issue tracking system.

More specifically, an end-user feedback reporting framework bundled with a particular client application may be configured to access (and/or may be bundled with) an issue report template prepopulated with information related to that particular client application, such as the application's name, a project of the issue tracking service associated with the client application tracked by the issue tracking system (which can include an issue tracking service), a team of developers assigned to maintain or manage issue reports regarding the client application, and so on.

In these examples, the end-user feedback reporting framework can access or copy the prepopulated, application-specific, issue report template and can insert the unstructured text input received from the user into a description portion of that template. In addition, the end-user feedback reporting framework can leverage one or more of graphical user interface element identifiers to identify a project, individual, or team that should receive this issue report.

For example, in some embodiments, the end-user feedback reporting framework can be configured to access a repository service to determine a file or set of files that define the identified graphical user interface element and, once such files are identified, can query the repository service to determine which developer or set of developers most recently changed that code. This information can thereafter be added to the yet-unsubmitted prepopulated, application-specific, issue report template. In further embodiments, additional information from the repository service and/or the issue tracking service (or another service provided by a collaborative software development environment, such as described herein) can be obtained and inserted into the issue report template which, in turn, can be submitted to the issue tracking service.

In view of the foregoing examples, it may be appreciated that generally and broadly, embodiments described herein leverage a framework or library that may be bundled with each client application distributed to end-users by a particular software development organization. The framework is configured to communicably couple to a particular issue tracking system or service managed by, and under the control of, the organization that distributed that software application product. The framework can be architected or otherwise designed as a “drop-in” framework requiring minimal or no configuration by software development teams of that organization. The framework may be configured before release (e.g., via a static configuration file distributed with the client application and framework), in the field (e.g., the framework may be configured to access a remote server or service to obtain a configuration file), or may be configured manually by an end-user of the client application.

The framework can be distributed, packaged, or otherwise bundled with, and/or may have access to, one or more prepopulated issue report templates that include information identifying the client application and/or the particular end-user or client device executing the client application. These templates can be leveraged by the framework to generate issue reports to the particular issue tracking system or service with which the framework is configured to communicate.

The framework can be configured to obtain a number of suitable data items and/or debug files that may be appended to, or otherwise attached to, issue reports transmitted by the framework to the issue tracking system or service. Examples include but are not limited to: debug logs; crash reports; client device information; client application information (e.g., version, uptime, and so on); memory profile information; memory utilization information; processor profile information; processor utilization information; network profile information; network utilization information; and so on.

The framework can be further configured to identify at least one specific graphical user interface element (e.g., by a graphical user interface element identifier, a universally-unique identifier, a hash, and so on). The framework can identify such user interface elements based on direct or indirect user input. More specifically, in some examples, an end-user may particularly identify (e.g., via selection) one or more user interface elements whereas in other examples, the framework may be configured to detect which user interface elements the end-user most recently interacted.

Thereafter, the framework can be configured to transmit a populated issue report to the issue tracking system or service. In this manner, end-user feedback (which may be undetailed and/or unstructured) may be supplemented along with additional relevant contextually-appropriate data to an issue tracking service and can be automatically added to an appropriately-detailed issue report submitted to a specified issue tracking system or service.

For example, an Organization can task a Software Development Team with maintaining an Email Application. The team leverages an Issue Tracking Service to track bugs in the software that defines the Email Application. A member of the team, Developer 1, is specifically tasked with maintaining features related to sending email and another member of the team, Developer 2, is specifically tasked with maintaining features related to authentication. In this example, the software development team can bundle a Framework, such as described herein, with the Email Application such that an instance of the Framework is distributed to each end-user that uses the Email Application.

A User of the Email Application may identify a bug in the Email Application that manifests after the User presses a button labeled “Compose.” The User may desire to report that bug to the Software Development Team. To accomplish this objective, the User may press a button labeled “Report Feedback” introduced by the Framework to a graphical user interface of the Email Application. The Framework can thereafter present an overlay dialog box requesting that the User select at least one user interface element that relates the User's feedback. In response, the User may select the button labeled “Compose.” The Framework can thereafter present a second overlaid dialog box requesting any additional details from the User, such as the User's name, a description of the expected and observed behavior, a rating on a graduated scale of the severity or annoyance of the bug, and so on. Thereafter, the User may select a button labeled “Submit” and may continue using the Email Application.

In the background, while or before the User provides additional information to the second overlaid dialog, the Framework can retrieve a unique identifier that identifies the button labeled “Compose.” With this identifier, the Framework can submit a query to the Issue Tracking Service to determine which developer is responsible for maintaining code that defines the button labeled “Compose.” The Issue Tracking Service may, in response, provide a response to the Framework identifying Developer 1.

In some embodiments, the Framework may also solicit or automatically collect demographic and/or usage statistics of the User. Examples include, but are not limited to: usernames; email addresses; employer; job title; Email Application licensee information; and so on. In some embodiments, demographic information can be captured only after express permission is received from the User.

Thereafter, also in the background, while or before the User provides additional information to the second overlaid dialog, the Framework can select an issue report template from one or more issue report templates. The templates may be bundled with the Email Application and may take any suitable form or format. The selected issue report template can include certain prepopulated information such as but not limited to: an identifier of a particular repository that stores code defining the Email Application; an identifier of the Software Development Team; an identifier of Developer 1 or Developer 2; an identifier of the Organization; demographic information of the User; and so on.

In this example, the Framework can receive the User's input, inputs received from the Issue Tracking Service, and/or other information that may be captured or obtained related to functionality of the Email Application near in time to the User's input (e.g., crash reports, debug logs, memory profiles or utilization statistics, processor profiles or utilization statistics, screen recordings, screen shots, and so on) and can insert such information into the selected issue report template. For example, unstructured text typed by the User may be inserted into a description field of the issue report template (which may be translated from one language to another by a language translation service), whereas Developer 1's name may be inserted into an assignee field of the issue report template. Similarly, demographic information of the User may be inserted into a reporter field of the issue report template.

In this manner, the User's minimal text input and selection of the button labeled “Compose” may be leveraged to provide a detailed and information-rich, properly-formatted, issue report to the Issue Tracking Service that, when received by that system, notifies Developer 1 that a new task has been assigned to Developer 1 by the Issue Tracking Service.

In view of the foregoing and following description, it may be appreciated that embodiments described herein reference a framework, library, or other precompiled or otherwise bundled application plugin that may be included with client applications distributed to end-users. The framework can be distributed with application-specific configuration files (and/or a capability to access a configuration file from a remote resource) that can be leveraged by the framework to communicably couple to a specific remote collaborative software development environment service, such as an issue tracking service. In addition, the framework can be distributed with application-specific issue report templates (and/or a capability to access an issue report template from a remote resource) that can be leveraged by the framework to communicate with the remote collaborative software development environment service, such as the issue tracking service. In addition, the framework can be configured to integrate with a graphical user interface of the client application such that an end-user can select individual user interface elements in relation to which the user desires to provide feedback. Developers of the client application may label each graphical user interface element of the client application with unique identifiers, such as universally unique identifiers, that can be captured by the framework and added to any communication(s) between the framework and the remote collaborative software development environment service, such as the issue tracking service. In still further examples, developers of the client application may label each graphical user interface with a string, which may be parseable or otherwise executable by the framework. For example, a developer may label a graphical user interface element of a client application with a uniform resource identifier (“URI”) path or string, such as “report_app://?ui_id=123;dev=jdoe;project=321” that embeds information about which developer is responsible for that graphical user interface element, which project is associated with that user interface element, and so on. In this example, the framework can extract information from the URI string to include in an issue report communicated back to the issue tracking service. In other examples, developers of the client application may label graphical user interface elements with computer-readable or human-readable strings that may be parsed by the framework into an instance of a data structure or object (e.g., Javascript object notation, extensible markup language, and so on). In still further examples, the framework may be configured to leverage accessibility identifiers or localization strings associated with graphical user interface elements as inputs to one or more issue reports. In still further examples, the identifier or string associated with a particular graphical user interface element may comprise executable code or an executable instruction.

As such, generally and broadly, it may be understood that a framework as described herein is configured to integrate with, and ship with, a client application. The framework facilitates communication between an end-user of the client application and a service of a collaborative software development environment leveraged by a developer of the client application. The framework provides a non-technical end-user of the client application a convenient interface for providing free-form user feedback (e.g., in the form of unformatted or unstructured strings). In addition, the framework provides a developer of the client application receiving the user input with additional information supplemental to the user input (such as crash logs, screen shots, screen recordings, user interface element identifiers which may include embedded information, such as developer or project information, and so on). In this manner and as a result of these described and other equivalent architectures, a framework such as described herein can benefit both developers and end-users of software products alike, dramatically simplifying processes of providing and receiving meaningful end-user feedback into collaboration tools, such as issue tracking services, leveraged by software developers.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways.

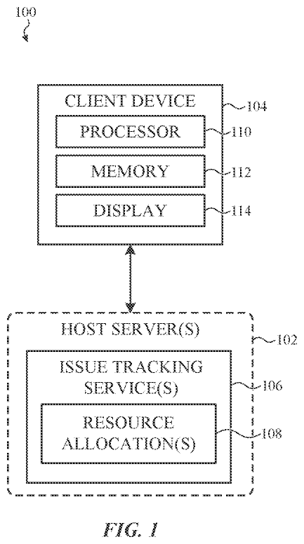

These foregoing and other embodiments are discussed below with reference to FIGS. 1-8. However, those skilled in the art will readily appreciate that the detailed description given herein with respect to these figures is for explanation only and should not be construed as limiting.

FIG. 1 is a schematic representation of an example issue tracking system 100 which is implemented with a client-server architecture including a host server 102 that communicably couples (e.g., via one or more networking or wired or wireless communication protocols) to a client device 104. It may be appreciated that other client devices may be configured in a substantially similar manner as the client device 104, although this may not be required of all embodiments and different client devices can be configured differently and/or may transact data or information with, and/or provide input(s) to, the host server 102 in a unique or device-specific manner.

In many embodiments, the host server 102 is configured to operate within or as a virtual computing environment that is supported by one or more physical servers including one or more hardware resources such as, but not limited to (or requiring) one or more of: a processor; a memory (also referred to as a working memory); non-volatile storage (also referred to as persistent memory); networking connections; input elements; and the like.

The host server 102 can leverage such resources to instantiate a number of discrete subservices or purpose-configured modules, containers, virtual or physical networks, or virtual machines each configured to perform, coordinate, host, serve, or otherwise provide one or more services, functions, or operations of the host server 102, such as an issue tracking service 106. In one example, the issue tracking service 106 is hosted by a virtual machine or container executing over physical resources of the host server 102. It may be appreciated, however, that this is merely one example construction and that in other embodiments other issue tracking services and/or other services of a collaborative software development environment can be provided.

More specifically, the issue tracking service 106 can be configured to receive from an end-user feedback reporting framework, such as described herein, executing with a client application instantiated by the client device 104 (e.g., via user input provided through a graphical user interface rendered on a display, provided by the end-user feedback reporting framework, or any combination thereof), without limitation: a request to open, create, or report an issue in a particular project; a request to modify an existing issue; a request to close an existing issue; a request to link an existing issue to another issue; a request to assign an issue to a particular user; and the like. More generally and broadly, however configured or implemented, the issue tracking service 106 of the host server is configured to manage and maintain a record of issues reported in one or more software development projects.

In addition, as noted above, the issue tracking service 106 of the host server 102 can be configured to communicably couple to the end-user feedback reporting framework executing on the client device 104 in order to exchange information with and/or receive input(s) from the end-user feedback reporting framework in the course of tracking and/or documenting progress of completion of one or more issues of one or more projects tracked by the issue tracking service 106.

The client device 104 can be any suitable personal or commercial electronic device and may include, without limitation or express requirement, a processor 110, volatile or non-volatile memory (identified, collectively, as the memory 112), and a display 114. Example electronic devices include, but are not limited to: laptop computers; desktop computers; cellular phones; tablet computing devices; and so on. It may be appreciated that a client device 104, such as described herein, can be implemented in any suitable manner.

In many embodiments, the processor 110 of the client device 104 can be configured to execute an application (a “client application”) stored, at least in part, in the memory 112. The client application can be distributed and/or bundled with an end-user feedback reporting framework which may be a library, a framework, an application plugin, or may take any other suitable structure or form.

The end-user feedback reporting framework can be used to access and communicate with the host server 102 and to securely transact information or data with, and provide input(s) to, the host server 102 and in particular services of the host server 102 such as the issue tracking service 106.

As a result of these architectures, an end-user can leverage the client device 104 to launch the client application and to, in addition to using the client application for its intended purpose, conduct tests to the client application that may result in the end-user discovering one or more bugs or issues that the end-user may desire to report to developers of the client application.

As with other embodiments described herein, the end-user feedback reporting framework can integrate with a graphical user interface of the client application instance executing on the client device 104. For example, the end-user feedback reporting framework may be configured to hook into the graphical user interface in order to add an additional element, such as a button soliciting feedback or a menu item soliciting feedback. In another examples, the end-user feedback reporting framework can be configured to overlay a graphical user interface, such as a drawer or a floating window that solicits feedback from the user. The preceding examples are not exhaustive; it may be appreciated that in different embodiments, an end-user feedback reporting framework such as described herein can provide or otherwise be associated with any number of suitable graphical user interfaces, user interface elements, and the like.

Regardless of implementation, the end-user feedback reporting framework may be configured to receive a user input (e.g., via user interaction with a button, a user providing a particular user gesture such as a touch gesture, or any other suitable user input) and, in response, can be configured to cause at least one of the end-user feedback reporting framework or the client application itself to transition to an end-user feedback mode in which feedback information is collected from the end-user.

For example, when the client application and/or the end-user feedback reporting framework transitions into an end-user feedback mode, one or more normal operations of the client application may be halted or otherwise blocked while user feedback information is collected. For example, the end-user feedback reporting framework may cause a graphical user interface of the client application to stop responding to user feedback, may block the graphical user interface such that the end user can select one or more user interface elements to add to an issue report, and so on.

In other cases, an end-user feedback reporting framework such as described herein may be configured to operate in the background or substantially in the background and may not block the graphical user interface of the client application at all.

For example, in one embodiment, the end-user feedback reporting framework generates a transparent or semitransparent overlay over the graphical user interface of the client application. As a result of this overlay, any user input provided by the end-user to the graphical user interface of the client application is blocked and/or otherwise intercepted by the transparent overlay.

In another example, the end-user feedback reporting framework can cause the client application to stop responding to user input by issuing an instruction to the graphical user interface and/or to the client application.

In yet another example, the end-user feedback reporting framework can instruct an operating system supporting executing of the client application to block user input for a period of time or at least until a second command is received from the end-user feedback reporting framework, the client application, or another application.

The foregoing examples are not exhaustive; it may be appreciated that in certain embodiments, an end-user feedback reporting framework such as described herein may be configured to facilitate blocking of a graphical user interface of a client application in a another manner. In yet other examples, as noted above, blocking of the graphical user interface of the client application may not be required. In yet further examples, only a portion of the graphical user interface of the client application may be blocked.

As a result of transitioning to an end-user feedback mode, a number of discrete information items, data items, metadata items, and/or other data items or pieces of information can be captured by the end-user feedback reporting framework. For example, the end-user feedback reporting framework can cause to be rendered a graphical user interface (e.g., which may overlay the graphical user interface of the client application) that solicits unstructured free-form text input from the end-user. This interface may include one or more text instructions soliciting a description from the user, a title of the user's feedback, a rating of the user's feedback's severity, and so on. These examples are not exhaustive; in some examples, the end user may be presented with a multi-field form, a single field form, an audio description/recording button, a video recording button, and so on. A person of skill in the art may appreciate a number of suitable methods of soliciting and capturing textual, audio, video, and/or combinations thereof information from an end-user are possible and may be appropriate or preferred in particular embodiments. In further examples, additional information may be requested and/or collected while the end-user feedback reporting framework and/or the client application are in the end-user feedback mode.

For example, as noted with respect to other embodiments described herein, in some examples, the graphical user interface of the client application may be blocked (e.g., does not respond to user input) so that the end-user can select one or more graphical user interface elements to note in a bug report or feedback report. In addition to, or in place of, selecting one or more graphical user interface elements, after transitioning to the end-user feedback mode, the end-user feedback reporting framework can capture, record, or otherwise log the end-user's interactions with the client application, along with logs, processor utilization, memory utilization, crash reports, user interface hangs, and so on. Once a debugging session has completed (e.g., marked as completed by the end-user by selecting a “submit” button or a “close” button rendered in a graphical user interface by the end-user feedback reporting framework and/or the client application), the information captured during the end-user feedback mode can be added to an issue report template and, thereafter, submitted to the issue tracking service 106 via the end-user feedback reporting framework.

For example, the end-user feedback reporting framework may have access to and/or may be distributed with multiple discrete issue report templates that can, in some embodiments, be prepopulated with information relevant to and descriptive of the client application itself. For example, each or some of a set of issue report templates accessible to the end-user feedback reporting framework may identify the client application by name and may also identify a project tracked by the issue tracking service 106 that, in turn, hosts code that defines the (e.g., compiles to) the client application. In addition, in certain embodiments, each or some of a set of issue report templates accessible to the end-user feedback reporting framework can include pointers to software developer teams responsible for the project or projects associated with the client application. In these examples, the end-user feedback reporting framework can leverage a selected template's content to generate an issue report with complete and comprehensive information that may be submitted to the issue tracking service 106.

In one specific example, a team of software developers leveraging systems and methods described herein may produce two separate software products, Product A and Product B. In these examples, a set of issue report templates distributed with a framework bundled with Product A may be different than a set of issue report templates distributed with a framework bundled with Product B. In particular, as one example, report templates distributed with Product A may be prepopulated with information specific to Product A (e.g., project name, developer name(s), user story identifiers, epic identifiers, and so on). Similarly, report templates distributed with Product B may be prepopulated with information specific to Product B. It may be appreciated that the foregoing examples are not exhaustive of the various data items or prepopulated fields that may be suitable or preferred in all embodiments. Some embodiments can include a single prepopulated issue report template with a framework, such as described herein, whereas others may include multiple templates. Still further embodiments may include no prepopulated templates but may instead include formatted data or other computer-readable data that may be read or otherwise extracted by a framework, such as described herein, and inserted into a blank issue report template (such as a web form). More generally, it may be appreciated that a framework such as described herein can be configured to supplement end-user input data in any suitable manner. Example data that can supplement user input can include, but may not be limited to: project data; epic data; team data; developer data; developer contact information; company data; software development licensee data; processor utilization data; memory utilization data; network utilization data; graphical user interface element data or identifiers; battery or power source data; client device sensor data (e.g., accelerometer data, display data, battery data, gyroscope data, touch input data, touch gesture data, and so on); and so on.

For example, in one embodiment, the client application is a game of chance application. Through the course of using/testing the game of chance application, the end-user may discover a user interface bug that presents an incorrect score. In this example, the end-user can select a button or menu item injected by the end-user feedback reporting framework to indicate that the end-user desires to provide feedback. As with other embodiments described herein, the client application and/or the end-user feedback reporting framework can transition to an end-user feedback mode. More specifically, when in the end-user feedback mode, the end-user can operate a graphical user interface presented by that framework to provide feedback to the creators of the game of chance application or, more technically, can operate the graphical user interface presented by the framework to input information that may be used by the framework to create a new issue report that may be submitted to an issue tracking service, such as described herein. The graphical user interface presented by the framework may be overlaid over a graphical user interface of the client application, may displace and/or replace the graphical user interface of the client application, or may be presented in any other suitable manner.

For example, the end-user can populate fields of an overlaid graphical user interface with bibliographic information, such as a title (e.g., “Score not showing properly”) , the end-user's name (e.g., “John Doe”), and so on. The end-user may also provide a plain text description of the observed behavior.

The end-user feedback reporting framework can receive these inputs from the user and can perform one or more tasks therewith, or in response to receiving the same. For example, in a simple example, inputs from the end-user can be combined along with other supplemental data, such as referenced above (e.g., crash logs, utilization profiles, and so on), to populate an issue report template and send that template to an issue tracking service.

In other examples, the end-user feedback reporting framework can parse the end-user input to extract information therefrom and insert the extracted information into one or more fields of an issue report template, such as described above. For example, unstructured user input may include a phrase of “@mentions don't link to correct account in message feed.” From this unstructured input, the end-user feedback reporting framework can determine through a suitable parsing method or technique (e.g., which may include operations such as but not limited to lemmatization, semantic analysis, trained machine-learning models, semantic tagging, and so on) that a user mention feature associated with the message feed is not functioning. In particular, the end-user feedback reporting framework can determine that the type of malfunction relates to account linking. Each of these extracted data items (and associated links to entities tracked by an issue tracking system, such as projects, stories, developers, particular clients, and so on) can be inserted into an issue tracking template, such as described herein. A person of skill in the art may appreciate that there exist and may be discovered many suitable methods and techniques for parsing input text, and different techniques may be suitable in different implementations of embodiments described herein.

In other examples, the end-user feedback reporting framework can parse the end-user input in order to determine or otherwise estimate an issue severity. For example, the end-user feedback reporting framework can be configured to perform semantic analysis to determine whether the user input exhibits particular frustration. In such examples, the end-user feedback reporting framework can be configured to assign a higher priority to an issue report generated from the end-user input.

The foregoing embodiment depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, as noted above one example of a service provided by a collaborative software development environment is an issue tracking system. In further examples, additional or alternative services provided by a collaborative software development environment may be communicably coupled to an end-user feedback reporting framework such as described herein.

For example, an end-user feedback reporting framework may be configured to couple to a documentation service of a collaborative software development environment. In such examples, end-user input may be leveraged to correct typographical errors and/or may be leveraged to improve documentation clarity.

In other cases, an end-user feedback reporting framework may be configured to couple to a project management service of a collaborative software development environment. In such examples, end-user input may be leveraged to track project progress as it relates to particular user stores or epics or particular relevance to particular users.

In other cases, an end-user feedback reporting framework may be configured to couple to a messaging service of a collaborative software development environment. In such examples, end-user input may be provided directly to developers in real-time via the messaging service. In these examples, end-user input can be parsed or otherwise analyzed in order to direct that end-user input to an appropriate messaging recipient (e.g., a particular developer or team) or to an appropriate messaging channel.

As such, in view of the foregoing, it may be appreciated that an end-user feedback reporting framework, such as described herein, can facilitate communication between end-users of a software product to select services of a collaborative software development environment leveraged by developers of that product. In a broad and non-limiting phrasing, embodiments described herein leverage an end-user feedback reporting framework to provide a la carte access to services of a collaborative software development environment to end-users of a software product. The end-user feedback reporting framework (or frameworks if multiple are bundled with a single client application) facilitates communication between the end-user and the chosen a la carte service of the collaboration environment.

In this sense, an end-user feedback reporting framework serves as an edge-based application programming interface or wrapper that allows an instance of a client application executing on a client device to communicate with a particular, selected, service of a collaboration tool. The end-user feedback reporting framework in these examples serves as a buffer between end-users and developer tools; developers of the client application need not specially program a feedback intake system, need not develop an in-house pipeline for review and consumption of end-user input, need not learn or reference any exposed application programming interfaces of collaboration tools they leverage, and so on. Instead, these developers can leverage an end-user feedback reporting framework that facilitates communication between the developer's applications and the developer's chosen software development environment(s).

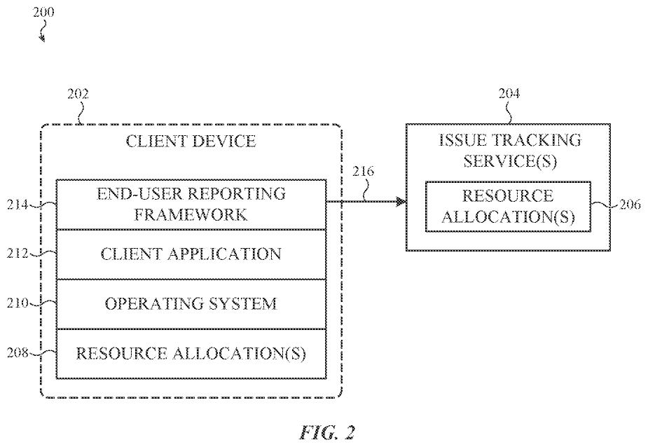

These foregoing examples are not exhaustive; it may be appreciated that many implementations and architectures are possible in view of these and other described embodiments and examples. For example, FIG. 2 depicts an example client device executing an instance of a client application including an end-user feedback reporting framework, such as described herein, that may communicably couple to an issue tracking service, such as depicted in FIG. 1.

In this example, the system 200 includes a client device 202 that can communicably couple to an issue tracking service 204. The issue tracking service 204 may be instantiated by a host server, such as the host server 102 of FIG. 1 and may be configured in a similar manner; this description is not repeated. The issue tracking service 204 can be supported by and/or instantiated by and/or with one or more physical or virtual resources (e.g., processor, memory, networking connections, and so on) represented in the figure for simplicity of illustration as the resource allocation 206. It may be appreciate that the resource allocation may include a processor allocation, a memory allocation, a networking connection, or any other suitable allocation of physical or virtual resources.

As with the example in FIG. 1, the client device 202 can be configured in a number of suitable ways to leverage a number of different hardware configurations. Example hardware components that can be included in a hardware configuration leveraged by and/or otherwise defining an operation or function of the client device 202 can include, without limitation: a processor; a persistent memory; a working memory; network connection(s); displays; input devices; peripheral connections; and the like. More generally, it may be appreciated that the client device 202, like the issue tracking service 204, can be supported by and/or instantiated by and/or with one or more physical or virtual resources represented in the figure, for simplicity of illustration, as the resource allocations 208.

In many implementations, the client device 202 leverages an operating system 210 to facilitate communications between software level services and the resource allocations 208. The operating system 210 can, in turn, be leveraged to instantiate a client application 212 that can be bundled with an end-user reporting framework 214, such as described herein. As a result of this construction, the end-user reporting framework 214 can communicably couple (e.g., via a secure or encrypted communication channel, which may include the open Internet, identified in the figure as the communication link 216) to the issue tracking service 204. As a result of this construction, whenever the client application 212 instantiates, the end-user reporting framework 214 can also be instantiated and may establish a communication link 216 with the issue tracking service 206. The communication link 216 may be persistent or may be established on demand. In some cases, a heartbeat signal may be transmitted between the client device 202 and the issue tracking service 204, but this may not be required of all embodiments.

In other examples, other architectures may be possible. For example, in some embodiments, a host operating system may not be required; the client application may be containerized and/or virtualized.

The foregoing embodiment depicted in FIG. 2 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

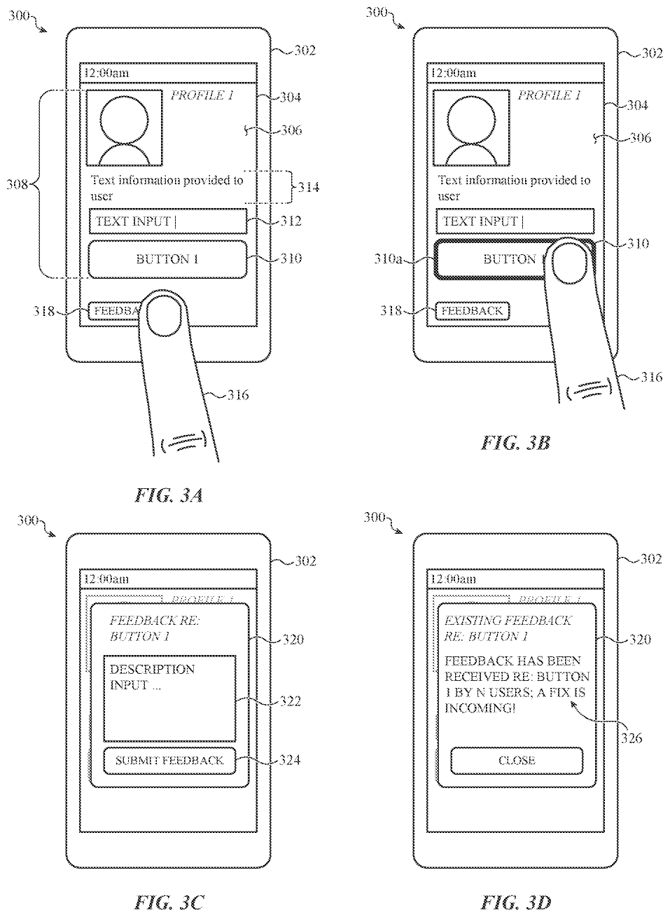

For example, FIGS. 3A-3D depict example graphical user interfaces that may be rendered by an instance of a client application, such as the client application of FIG. 2, to facilitate interaction between a user of the client application, an end-user feedback reporting framework such as described herein, and an issue tracking service, such as depicted in FIG. 1.

FIG. 3A, and likewise related FIGS. 3B-3D, depicts a client device 300 that can instantiate an instance of a client application such as described herein. More particularly, in these examples, the client device 300 can be any suitable computing resource or computing device configured to be execute at least one software application and configured to be operated, at least in part, by an end-user, such as described herein. In the illustrated example embodiment, the client device 300 is a computing resource that includes a housing 302 that encloses and supports a display 304 that, in turn, can be used by a client application to render a graphical user interface 306.

As used herein, the term “computing resource” (along with other similar terms and phrases, including, but not limited to, “computing device” and “computing network”) may be used to refer to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

For simplicity of description, the embodiments that follow reference an example electronic device or computing resource implemented as a personal mobile electronic device; it is appreciated that this is merely one example and that in other embodiments, other constructions are possible.

As with other embodiments described herein, the client application executing on the client device 300 can take any suitable form and may perform or coordinate any number of suitable functions. In FIG. 3A, an example graphical user interface 306 is provided, but it is appreciated that this is merely one example and that the depicted user interface is merely provided for purposes of explanation and illustration.

Also as with other embodiments described herein, the client application executing on the client device 300 can be distributed with an end-user feedback reporting framework that can communicably couple to, as one example, an issue tracking service of a collaborative software development environment such as described herein.

The end-user feedback reporting framework, as with other embodiments, can be configured to integrate with the graphical user interface 306 in a number of suitable ways to solicit and receive feedback from an end-user. For example, in the illustrated embodiment, the graphical user interface 306 can include a number of discrete graphical user interface elements 308. Each of these elements can be configured for a different purpose which may vary from embodiment to embodiment. For example, the graphical user interface 306 can include, without limitation or express requirement: a button 310; a text input field 312; a text description/information field 314, and so on. Each of these discrete graphical user interface elements 308 can be leveraged by an end-user 316 to interact with the client application. In the illustrated example, the display 304 may be implemented with touch and/or force input sensors configured to receive touch and/or force input from the end-user 316. In other implementations, the graphical user interface may be configured to receive user input in another manner.

As noted above, the end-user feedback reporting framework can integrate with graphical user interface 306 in a number of suitable ways. For example, as shown in FIG. 3A, the end-user feedback reporting framework can be configured to inject into the graphical user interface 306 a button 318 that solicits feedback from the end-user 316. In other examples, the client application may be configured to render the button 318, which in turn can inform the end-user feedback reporting framework and/or the client application that the end-user 316 intends to provide feedback.

In other cases, a physical button may not be required. For example, in some embodiments, the end-user feedback reporting framework may hook into a touch input sensor of the client device 300. In these examples, the end-user 316 can inform the end-user feedback reporting framework that the end-user 316 intends to provide user feedback by providing a particular touch gesture. The foregoing examples are not exhaustive; it may be appreciated that in different architectures, different means of soliciting user feedback from the end-user 316.

As with other embodiments described herein, the end-user feedback reporting framework can transition to an end-user feedback mode after receiving an indication from the end-user 316 that the end-user 316 desires to provide feedback to the developers of the client application. In other words, for the illustrated embodiment, after the end-user 316 engages the button 318, the end-user feedback reporting framework can block the graphical user interface 306 or, in other constructions, can instruct the client application and/or the graphical user interface 306 to stop receiving user input. As a result of this construction, the end-user feedback reporting framework can request from the user (not shown) an indication of which graphical user interface element the end-user intends to provide feedback. In one embodiment, the end-user feedback reporting framework can generate a popup dialog asking the end-user 316 to select one or more graphical interface elements about which the user desires to provide feedback. In other cases, an audio or visual instruction may be triggered by the end-user feedback reporting framework that informs the end-user 316 of an option to select one or more graphical user interface elements. It may be appreciated that these foregoing examples are not exhaustive; in other examples, an end-user feedback reporting framework and/or a client application such as described herein can solicit selection of a graphical user interface element about which the end-user 316 desires to provide feedback in a number of suitable ways.

In many examples, the graphical user interface 306 can be configured to provide a visual indication of which element(s) are selected by a user. For example, as shown in FIG. 3B, if the user selects button 310, a border 310a of that button can be highlighted to emphasize for the end-user 316 that the button 310 has been properly selected. In other cases, a border or boundary may not be changed; the button 310 can be emphasized in any other suitable manner.

Once the end-user optionally selects at least one graphical user interface element about which to provide feedback, the end-user feedback reporting framework can generate a graphical user interface supplemental to the graphical user interface 306. For example, as shown in FIGS. 3C-3D, a second graphical user interface 320 may overlay the graphical user interface 306. The second graphical user interface 320 can be leveraged by the end-user feedback reporting framework to receive free-form or otherwise unstructured text input from the end-user 316. For example, as shown in FIG. 3C, a text input area 322 (or, more generally, an end-user input field) can be shown to receive a free-form text description of the feedback provided by the user. Once the user has completed his or her description of the issue, the end-user may select a submit button 324.

As described above, in the background, the end-user feedback reporting framework can perform a number of functions while or before the end-user 316 provides text input to the text input area 322. For example, the end-user feedback reporting framework can select an issue report template and begin populating various fields of that issue report template. For example, information or data that may be populated by or obtained by the end-user feedback reporting framework, such as described herein can include, but may not be limited to: end-user bibliographic and/or demographic information (e.g., username, account name, email address, age, gender, and so on); logs; crash reports; stack traces; memory dumps; processor utilization data; memory utilization data; network utilization data; an identifier and/or other unique string or instruction associated with any selected graphical user interface elements selected by the end-user; and so on. All of this data or information can be inserted into one or more fields of an issue report template such as described herein.

In other examples, the end-user feedback reporting framework can be configured to communicate with an issue tracking service, such as described herein in order to determine whether an issue has already been reported to that system regarding at least one or more of the selected user interface elements selected by the user. For example, the end-user feedback reporting framework may submit a query to the issue tracking service to determine whether an existing issue or a recent issue references at least one of the graphical user interface elements selected by the end-user 216.

In these examples, if a duplicate issue report or a previously-filed issue report is identified by the issue tacking system and/or the end-user feedback reporting framework, then the end-user feedback reporting framework can cause a different graphical user interface to appear. For example, as shown in FIG. 3D, an information dialog 328 can be presented to the end-user 316 to inform the end-user 316 that other users have also provided similar feedback and that software developers are currently working to address any problems identified.

These foregoing embodiments depicted in FIG. 3A-3D and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, in other embodiments, an end-user feedback reporting framework such as described herein may be separate from individual client applications. In these examples, an end-user feedback reporting framework can be distributed with a host operating system, a containerization system, a virtualization system, or another suitable system or application layer service operating on or otherwise instantiated by a client device, such as described herein.

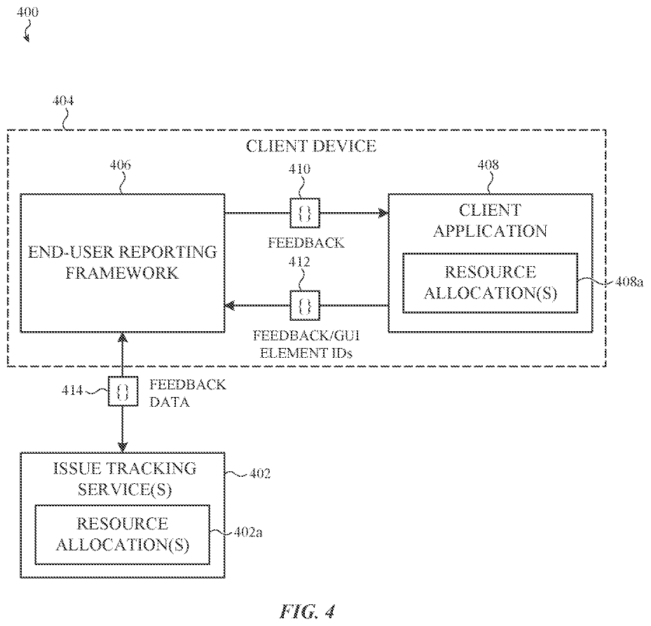

FIG. 4 depicts a simplified system diagram of a client device executing an instance of a client application and an instance of an end-user feedback reporting framework communicably coupled to an issue tracking service, such as depicted in FIG. 1.

In this example, an issue tracking service 402 (supported by the resource allocations 402a), can communicably couple to a client device 404 and, in particular, or an end-user feedback reporting framework 406 instantiated by that device. In turn, the end-user feedback reporting framework 406 can communicably couple to a client application 408 (supported, like the issue tracking service 402, by the resource allocations 408a.

In particular, the end-user feedback reporting framework 406 and the client application 408 may exchange and/or transact a wide variety of information related to end-user feedback, such as but not limited to an indication from the end-user feedback reporting framework 406 and/or the issue tracking service 402 to the client application 408 that an issue report and/or user feedback has already been received (indicated in the figure as the feedback 410). In other examples, the client application 408 can send to the end-user feedback reporting framework 406 end-user feedback and/or one or more element identifiers (or, more simply, element “IDs”) corresponding to specific user interface elements selected by the end-user (indicated in the figure as the feedback/element IDs 412). Such information received by the end-user feedback reporting framework 406 can be aggregated and/or otherwise added to an issue report template that, in turn, can be communicated back to the issue tracking service 402 by the end-user feedback reporting framework 406 as the feedback data 414.

The foregoing embodiments depicted in FIG. 4 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

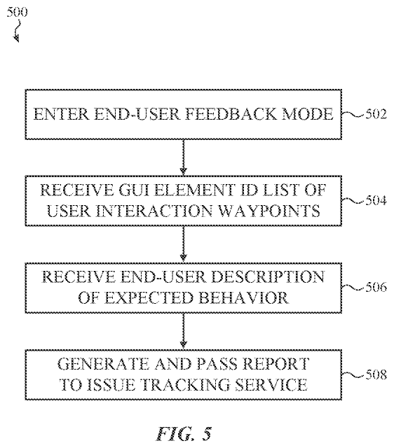

FIG. 5 is a flowchart depicting example operations of a method of leveraging end-user feedback to provide input to an issue tracking service, such as described herein. As with many embodiments and in particular methods described herein, the method 500 can be performed in whole or in part by an end-user feedback reporting framework, such as described herein. The end-user feedback reporting framework may be instantiated with a client application.

The method 500 includes operation 502 at which a client application and/or the end-user feedback reporting framework transition to an end-user feedback mode. For example, as noted with respect to many embodiments described herein, the end-user feedback reporting framework can integrate with a graphical user interface rendered by the client application and can present to the user an overlaid interface that provides the end-user with an input text area to input free-form text as input.

Prior to displaying the secondary/overlaid graphical user interface, the method 500 can advance to operation 504 at which the end-user is asked (e.g., by the end-user feedback reporting framework and, in particular, the graphical user interface rendered or modified by the end-user feedback reporting framework) to select at least one graphical user interface element. If the user selects more than one graphical user interface element, the end-user feedback reporting framework and/or the client application can be configured to record a unique identifier associated with each graphical user interface element and can be configured to record an order in which those elements were selected by the end-user. In this manner, the end-user feedback reporting framework may be configured to generate a list of graphical user interface waypoints the end-user followed while providing feedback.

Thereafter, at operation 506, the method 500 can receive direct user input describing expected or desired behavior. As with other embodiments described herein, this may be presented in the form of free-form text. In other examples, this may be presented as well-formatted or richly formatted text. It may be appreciated by a person of skill in the art that any suitable user input can be received and processed.

Finally at operation 508, the end-user feedback reporting framework may be configured to aggregate information collected through operations 502-504, populate a selected issue report template with that information, and submit the information as a new issue report to an issue tracking service, such as described herein.

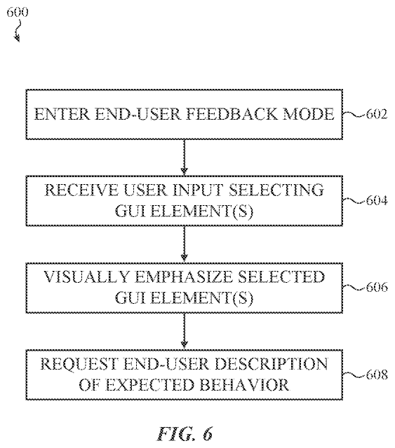

FIG. 6 is a flowchart depicting example operations of a method of collecting end-user feedback to provide input to an issue tracking service, such as described herein. As with many embodiments and in particular methods described herein, the method 600 can be performed in whole or in part by an end-user feedback reporting framework, such as described herein. The end-user feedback reporting framework may be instantiated with a client application.

As with the method 500, the method 600 includes an operation 602 in which an end-user feedback reporting framework and/or a client application (such as described herein) may transition to an end-user feedback reporting mode. In many embodiments, the end-user feedback reporting framework and/or the client application may transition to the end-user feedback reporting mode upon receiving an input from an end-user indicating an intention to provide user feedback. As with other embodiments described herein, the user input may take the form of a button press (e.g., engaging a “feedback” button), a gesture (e.g., a touch input gesture), a command (e.g., a voice instruction), and so on.

At operation 604, the method 600 advances to receive one or more selections by the end-user of one or more graphical user interface elements about which the user desires to provide feedback. In these examples, at operation 606, the selected graphical user interface elements may be highlighted or otherwise emphasized in some manner (e.g., visually, haptically, or in another way).

Thereafter, the method 600 advances to operation 608 at which a secondary graphical user interface can be provided by the end-user feedback reporting framework that requests the end-user provide a plain text or other description of the observed or desired behavior. In other cases, the end-user feedback reporting framework may provide a means for the end-user to initiate a screen recording, to take and/or upload or attach screenshots, or provide input in another non-text manner. Each of these input(s) received from the end-user can be leveraged by the end-user feedback reporting framework to populate an issue report template, such as described herein, which in turn may be submitted as a new issue report to the issue tracking service.

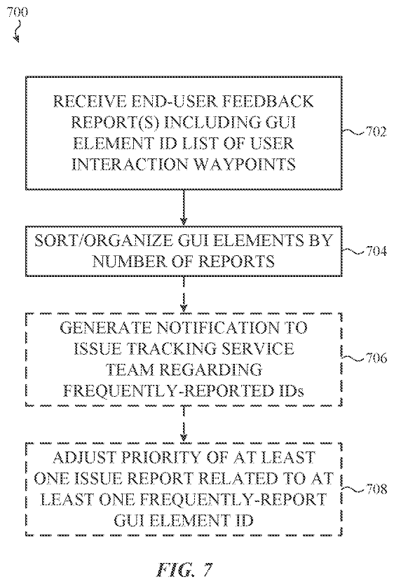

FIG. 7 is a flowchart depicting example operations of a method of leveraging end-user feedback to modify how content is displayed or prioritized in an issue tracking service, such as described herein. As with many embodiments and in particular methods described herein, the method 700 can be performed in whole or in part by an end-user feedback reporting framework and/or an issue tracking service such as described herein. The end-user feedback reporting framework may be instantiated with a client application.

The method 700 includes operation 702 at which end-user feedback is received in the form of a new issue report in turn received from an end-user feedback reporting framework, such as described herein. In this example, the feedback received from the end-user feedback reporting framework can include at least one graphical user interface element identifier and/or a list of waypoints that correspond to the feedback provided by the user.

At operation 704, the method 700 advances to determine whether any issue reports have been received by the issue tracking service that reference any of the graphical user interface element IDs received at operation 702. In a circumstance in which at least two previous issue reports have been received, the method 700 may sort the list of selected graphical user interface elements by number of issue reports referencing that element.

Thereafter, the method 700 advances to operation 706 at which a notification can be generated to a developer group or team identifying at least one graphical user interface element that has received at least a threshold number of issue reports from end-users. Finally, at operation 708, priority and/or severity of issues referencing frequently-reported graphical user interface element IDs can be increased. In one, non-limiting implementation, developers may be presented with a heat map or other graphical indication of which user interface elements are triggering the most frequent reports from end-users.

It may be appreciated that these foregoing examples are not exhaustive; other methods of parsing and/or extracting information from debugging data and appending that information to an issue report may be considered or implemented.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

1. A method for generating an issue report for input to an issue tracking service from unstructured end-user feedback about a client application, the method comprising:
receiving, at a first graphical user interface rendered by the client application executing on a client device, a first user input comprising an instruction to transition to an end-user feedback mode;
displaying an indication overlaid the first graphical user interface that the end-user feedback mode is active;
receiving, at the first graphical user interface, a second user input comprising a selection of a graphical user interface element displayed in the first graphical user interface;
blocking a function associated with the selected graphical user interface element;
extracting a string identifier identifying the selected graphical user interface element;
displaying, a second graphical user interface rendered by an end-user feedback reporting framework, over the first graphical user interface and at least partially obscuring the first graphical user interface the second graphical user interface comprising an end-user input field;
receiving, at the second graphical user interface, a third user input to the end-user input field the third user input comprising unstructured free-form text input;
selecting, while the user provides the third user input, based at least in part on the string identifier by the end-user feedback reporting framework, an issue report template;
populating, by the end-user feedback reporting framework:
a description field of the selected issue report template with third user input;
a project filed of the selected issue report template based on the client application; and
an assignee field of the selected issue report template based on the string identifier; and
transmitting the populated issue report template to the issue tracking service.

2. The method of claim 1, wherein the end-user feedback reporting framework is bundled with the client application.

3. The method of claim 1, wherein the issue report template is selected from a set of issue report templates bundled with the end-user feedback reporting framework.

4. The method of claim 1, wherein the first graphical user interface is blocked prior to receiving the second user input.

5. A collaborative software development comprising:
an issue tracking service instantiated by a host server; and
a client device comprising:
a processor allocation; and
a memory allocation storing executable instructions that, when executed by the processor allocation, cause the processor allocation to instantiate a client application, the client application comprising an end-user feedback reporting framework communicably coupled to the issue tracking service and configured to:
present a graphical user interface to a user of the client device;
receive a series of user input events via the graphical user interface;
extract a set of unique identifiers, each unique identifier associated with and identifying a respective one graphical user interface element associated with one respective user input event of the series of user input events;
select by the end-user feedback reporting framework an issue report template based on at least one of the set of unique identifiers;
populate the issue report template with at least one of the user input events and the set of identifiers;
populate a project field of the issue report template based on the client application;
populate an assignee field of the issue report template based on the at least one of the set of unique identifiers; and
submit the issue report template as an issue report to the issue tracking service.

6. The collaborative software development environment of claim 5, wherein:
the series of user input events is a first user input; and
the client application is configured to receive a second user input;
the second user input comprises a description of a graphical user interface bug; and
end-user feedback reporting framework is configured to populate the issue report template with the description.

7. The collaborative software development environment of claim 5, wherein:
the issue report template is selected by the end-user reporting framework from a set of issue report templates; and
the issue report template is selected at least in part on the series of user input events.

8. The collaborative software development environment of claim 7, wherein at least one issue report template of the set of issue report templates comprises at least one field prepopulated with information corresponding to the client application.

9. The collaborative software development environment of claim 5, wherein the client application corresponds to a project tracked by the issue tracking service.

10. The collaborative software development environment of claim 5, wherein:
the graphical user interface is a second graphical user interface;
the client application renders a first graphical user interface;
the second graphical user interface overlays the first graphical user interface and at least partially obscures the first graphical user interface.

11. The collaborative software development environment of claim 10, wherein the client application is configured to be operated in an end-user feedback reporting mode in which the first graphical user interface is at least partially blocked.

12. The collaborative software development environment of claim 11, wherein when in the end-user feedback reporting mode, the first graphical user interface is configured to receive a selection by an end-user of at least one graphical user interface element.

13. The collaborative software development environment of claim 12, wherein the end-user feedback reporting framework is configured to select the issue report template from a set of issue report templates based on at least one unique identifier of the set of unique identifiers.

14. The collaborative software development environment of claim 13, wherein the at least one unique identifier is a universally unique identifier or a text string.

15. The collaborative software development environment of claim 13, wherein the at least one unique identifier comprises an executable instruction.

16. The collaborative software development environment of claim 15, wherein the executable instruction is executed by the end-user feedback reporting framework.

17. A method for generating an issue report for input to an issue tracking service from unstructured end-user feedback about a client application, the method comprising:
receiving a first user input to a graphical user interface, the first user input comprising a selection of a graphical user interface element when the client application is in a user-feedback reporting mode;
blocking a function associated with the selected graphical user interface element;
retrieving, based on the selection, a unique identifier corresponding to the graphical user interface element
selecting, by the end-user feedback reporting framework bundled with the client application and specific to the client application, an issue report template based at least in part on the unique identifier;
populating, by the end-user feedback reporting framework, an assignee field of the issue report template based on the unique identifier; and
transmitting the populated issue report template to the issue tracking service.

18. The method of claim 17, further comprising setting a priority associated with the populated issue report template based on the unique identifier.

19. The method of claim 18, wherein the priority is based, at least in part, on a number of issue reports received by the issue tracking service that reference the unique identifier.

20. The method of claim 17, wherein upon receiving the selection, visually emphasizing the selected graphical user interface element in the graphical user interface.
